(19) United States
(12) Patent Application Publication
(10) Pub. No.: US 2026/0265443 A1
(43) Pub. Date: Sep. 10, 2026

(54) POLYURETHANE FOAM HAVING TUNEABLE POROSITY IN WIDE RANGE

(71) Applicant: SHELL USA, INC., Houston, TX (US)

(72) Inventors: Arvind KUMAR, Bangalore North (IN); Pranaya Man Singh PRADHAN, Singapore (SG); Prashant Anil TATAKE, Amsterdam (NL)

(21) Appl. No.: 18/869,314

(22) PCT Filed: Jun. 8, 2023
(86) PCT No.: PCT/EP2023/065356

§ 371 Date: Nov. 26, 2024

(30) Foreign Application Priority Data
Jun. 15, 2022 (EP) 22179120.5

(51) Int. Cl. C08G 18/48; C08J 9/228

(52) U.S. Cl. CPC C08G 18/4845; C08J 9/228; C08J 2375/08

(57) ABSTRACT

The invention relates to a process for preparing a polyurethane foam, comprising reacting a polyisocyanate with a polyether polyol component a) in the presence of a blowing agent, wherein polyether polyol component a) comprises: a1) a first polyether polyol having a molecular weight of from 300 to 1,500 g/mol, a hydroxyl value of from 100 to 650 mg KOH/g and a propylene oxide content above 50 wt. %; and a2) a second polyether polyol having a molecular weight of from 500 to 1,700 g/mol, a hydroxyl value of from 50 to 650 mg KOH/g, an ethylene oxide content above 30 wt. %, a propylene oxide content below 50 wt. % and a primary hydroxyl content below 40%.

### FIELD OF THE INVENTION

The present invention relates to a process for preparing a polyurethane foam, to a polyether polyol composition, to a polyurethane foam obtainable by said process, and to a shaped article comprising said polyurethane foam.

### BACKGROUND OF THE INVENTION

Polyurethane foams, in specific flexible polyurethane foams, have found extensive use in a multitude of industrial and consumer applications. For some applications flexible polyurethane foams may have a relatively low porosity, whereas for many other applications the foams should have a relatively high porosity.

One class of flexible polyurethane foam is known as viscoelastic (VE) or “memory” foam. Viscoelastic foams exhibit a time-delayed response to an applied stress (compression). They have low resiliency and recover slowly when compressed. These properties are often associated with the glass transition temperature (Tg) of the polyurethane. Viscoelasticity is often manifested when the polymer has a Tg at or near the use temperature, which is room temperature for many applications.

Like most polyurethane foams, VE polyurethane foams may be prepared by the reaction of a polyether polyol component with a polyisocyanate in the presence of a blowing agent. The blowing agent is usually water or a mixture of water and another material. VE formulations are often characterized by the selection of polyether polyol component and the amount of water in the formulation. The predominant polyether polyol used in these formulations may have a functionality of about 3 hydroxyl groups/molecule and a molecular weight in the range of 400-1,500. This polyol is primarily the principal determinant of the Tg of the polyurethane foam, although other factors such as water levels and isocyanate index also play significant roles.

Usually, VE polyurethane foam is produced at low isocyanate index (100 times the mole ratio of —NCO groups to NCO-reactive groups in the reaction mixture). Often, the isocyanate index is at most about 120, or even at most about 100 or at most about 90.

Typically, VE polyurethane foams have low air flow properties, generally less than about 1.0 standard cubic feet per minute (scfm) (28.2 liters/minute) under conditions of room temperature (22° C.) and atmospheric pressure (1 atm), therefore promoting sweating when used as comfort foams (for instance, bedding, seating and other cushioning). Low air flow also leads to low heat and moisture transfer out of the foam resulting in an increased temperature and an increased moisture level in the foam. The consequence of higher temperature is higher resiliency and lowered viscoelastic character. Combined heat and moisture result in accelerated fatigue of the foam. In addition, if foam air flows are sufficiently low, foams can suffer from shrinkage during manufacturing.

Polyurethane foams may be made by reacting a polyether polyol and a polyisocyanate in the presence of a blowing agent. It is known to vary foam porosity, which property is the resultant of cell-opening efficiency during foam production, by decreasing or increasing the amount of so-called “cell-openers”, which may be polyether polyols having a relatively high ethylene oxide (EO) content, a relatively high molecular weight and a relatively low hydroxyl (OH) number. WO2019086655 discloses the use of such cell-opening polyether polyol, in specific “Caradol SA36-02”. According to Table 6 of said WO2019086655, by increasing the amount of said polyol in making viscoelastic polyurethane foams, the porosity is likewise increased, from 8 l/min (at an amount of 2 pbw=parts by weight) to 28 l/min (at an amount of 8 pbw).

It would be advantageous to make polyurethane foam, especially viscoelastic (VE) polyurethane foam, in such a way that the foam porosity can be varied (tuned) over a wide range, for example of from 5 to 200 l/min, depending on the specific foam application and correspondingly required specific foam porosity, preferably while still retaining viscoelastic properties in case of VE polyurethane foam.

However, a polyurethane foam, especially a VE polyurethane foam, having such tuneable foam porosity as referred to above, should still meet other desired foam properties, such as foam stability during the production of foam. In specific, foam instability may be shown by a so-called “sink back” of the foam and/or by a relatively low foam height (low foam rise) and/or even by a split or a collapse of the foam. Said sink back refers to a phenomenon wherein after reaching a certain height the foam height is reduced. A disadvantage of such sink back is that the final foam density is not distributed evenly and/or that the final foam height is relatively low.

It is an object of the invention to provide a process for preparing a polyurethane foam, especially a viscoelastic (VE) polyurethane foam, which is prepared by reacting, in the presence of a blowing agent, a polyisocyanate and a polyether polyol, which foam has one or more of the above-described desired properties and advantages, including both foam stability and tuneability of foam porosity, that is to say variation of porosity over a wide range of porosities while still maintaining foam stability.

In addition, it may be an object of the invention to decrease the compression set and/or to increase the porosity of the polyurethane foam to be prepared in the above-mentioned process. Further, it may be an object of the invention to only use a relatively small number of different alcohols, including polyether polyols and monols, to achieve one or more of the above-described objects. An advantage of the latter is that less storage tanks, feeding lines, pumps, etc. are needed, which apart from being less expensive, may also reduce the risk of any cross-contamination.

### SUMMARY OF THE INVENTION

Surprisingly it was found that the above-mentioned objects may be achieved by combining a first polyether polyol having a relatively low molecular weight, a relatively high hydroxyl value and a propylene oxide content above 50 wt. % with a different, second polyether polyol also having a relatively low molecular weight and a relatively high hydroxyl value and further having an ethylene oxide content above 30 wt. %, a propylene oxide content below 50 wt. % and a primary hydroxyl content below 40%.

Accordingly, the present invention relates to a process for preparing a polyurethane foam, comprising reacting a polyisocyanate with a polyether polyol component a) in the presence of a blowing agent, wherein polyether polyol component a) comprises:
a1) a first polyether polyol having a molecular weight of from 300 to 1,500 g/mol, a hydroxyl value of from 100 to 650 mg KOH/g and a propylene oxide content above 50 wt. %; and
a2) a second polyether polyol having a molecular weight of from 500 to 1, 700 g/mol, a hydroxyl value of from 50 to 650 mg KOH/g, an ethylene oxide content above 30 wt. %, a propylene oxide content below 50 wt. % and a primary hydroxyl content below 40%.

The present invention also relates to a composition comprising the first polyether polyol and the second polyether polyol as described above.

Further, the present invention relates to a polyurethane foam obtainable by the above-mentioned process for preparing a polyurethane foam, and to a shaped article comprising a polyurethane foam obtained or obtainable by said process.

### DETAILED DESCRIPTION OF THE INVENTION

While the processes and compositions of the present invention may be described in terms of “comprising”, “containing” or “including” one or more various described steps and components, respectively, they can also “consist essentially of” or “consist of” said one or more various described steps and components, respectively.

In the context of the present invention, in a case where a composition comprises two or more components, these components are to be selected in an overall amount not to exceed 100 wt. %.

Where upper and lower limits are quoted for a property then a range of values defined by a combination of any of the upper limits with any of the lower limits is also implied. The term “molecular weight” (or “MW”) is used herein to refer to number average molecular weight, unless otherwise specified or context requires otherwise. The number average molecular weight of a polyol can be measured by gel permeation chromatography (GPC) or vapor pressure osmometry (VPO).

The term “hydroxyl (OH) value” or “hydroxyl (OH) number” is used herein to refer to the milligrams of potassium hydroxide equivalent to the hydroxyl content in one gram of polyol determined by wet method titration. Hence, said OH value or number is expressed in mg KOH/g.

The term “equivalent weight” (or “EW”) is used herein to refer to the weight of polyol per reactive site. The equivalent weight is 56,100 divided by the hydroxyl value of the polyol.

The term “functionality” or “hydroxyl (OH) functionality” of a polyol refers to the number of hydroxyl groups per molecule of polyol. The nominal functionality (or “Fn”) of a polyol is the same as that of its starter compound (initiator). Unless indicated otherwise, functionality refers to the actual average functionality which may be lower than the nominal functionality and is determined by the number average molecular weight of the polyol divided by the equivalent weight of the polyol.

The term “primary hydroxyl content” (or “PHC”) is used herein to refer to the relative proportion (in %) of primary hydroxyl groups in a polyether polyol based on total number of hydroxyl groups including primary and secondary hydroxyl groups.

The terms “ethylene oxide content” and “propylene oxide content”, respectively, in relation to a polyether polyol refer to those parts of the polyol which are derived from ethylene oxide and propylene oxide, respectively. Said contents may also be referred to as oxyethylene content and oxypropylene content, respectively. Further, said contents are based herein on total alkylene oxide weight.

The process of the present invention is a process for preparing a polyurethane foam, comprising reacting a polyisocyanate with a polyether polyol component a) in the presence of a blowing agent, wherein polyether polyol component a) comprises a1) a first polyether polyol and a2) a second polyether polyol.

In the present invention, polyether polyol component a) comprises two or more polyether polyols, including above-mentioned first and second polyether polyols and below-mentioned optional third polyether polyol, which are prepared by ring-opening polymerization of an alkylene oxide in the presence of an initiator having a plurality of active hydrogen atoms and a catalyst. Said catalyst may be a basic catalyst, such as potassium hydroxide (KOH), or a composite metal cyanide complex catalyst, which latter catalyst is frequently also referred to as double metal cyanide (DMC) catalyst. One or more initiators may be used in preparing said polyether polyols. Suitable initiators include polyfunctional alcohols, generally containing from 2 to 6 hydroxyl groups. Examples of such alcohols comprise glycols, glycerol, pentaerythritol, trimethylolpropane, triethanolamine, sorbitol and mannitol. Advantageously, monopropylene glycol (MPG), glycerol or a combination of both may be used as initiator(s).

In the present invention, the above-mentioned two or more polyether polyols in polyether polyol component a) comprise polyether polyols containing ether linkages (or ether units). Further, said polyether polyols may additionally contain ester linkages (or ester units) and/or carbonate linkages (or carbonate units). It is preferred that said polyether polyols do not contain ester linkages (or ester units). Further, it is preferred that said polyether polyols do not contain carbonate linkages (or carbonate units). Still further, said polyether polyols may consist of ether linkages.

In the present invention, the first and second polyether polyols are different from each other and should meet the following requirements:
a1) the first polyether polyol has a molecular weight of from 300 to 1,500 g/mol, a hydroxyl value of from 100 to 650 mg KOH/g and a propylene oxide content above 50 wt. %; and
a2) the second polyether polyol has a molecular weight of from 500 to 1,700 g/mol, a hydroxyl value of from 50 to 650 mg KOH/g, an ethylene oxide content above 30 wt. %, a propylene oxide content below 50 wt. % and a primary hydroxyl content below 40%.

The first and second polyether polyols are further described hereinbelow.

The first polyether polyol has a molecular weight of from 300 to 1,500 g/mol. The molecular weight of the first polyether polyol is at least 300 g/mol and may be at least 400 g/mol or at least 500 g/mol or at least 550 g/mol or at least 600 g/mol. Further, the molecular weight of the first polyether polyol is at most 1,500 g/mol and may be at most 1,250 g/mol or at most 1,000 g/mol or at most 900 g/mol or at most 800 g/mol.

Further, the first polyether polyol has a hydroxyl value of from 100 to 650 mg KOH/g. The hydroxyl value of the first polyether polyol is at least 100 mg KOH/g, more preferably at least 150 mg KOH/g, more preferably at least 190 mg KOH/g, most preferably at least 220 mg KOH/g. Further, the hydroxyl value of the first polyether polyol is at most 650 mg KOH/g, more preferably at most 500 mg KOH/g, more preferably at most 400 mg KOH/g, most preferably at most 300 mg KOH/g.

Further, the first polyether polyol has a propylene oxide content above 50 wt. %. The first polyether polyol comprises polyether chains containing propylene oxide content (more than 50 wt. %), optionally butylene oxide content and optionally ethylene oxide content.

Preferably, the propylene oxide content of the first polyether polyol is at least 70 wt. %, more preferably at least 80 wt. %, more preferably at least 90 wt. %, more preferably at least 95 wt. %, most preferably at least 99 wt. %. Further, preferably, the propylene oxide content of the first polyether polyol is at most 100 wt. %.

The ethylene oxide content of the first polyether polyol may be 0 wt. % or at least 3 wt. % or at least 5 wt. % or at least 10 wt. % or at least 12 wt. % or at least 15 wt. %. Further, the ethylene oxide content of the first polyether polyol may be below 30 wt. % or at most 25 wt. % or at most 20 wt. % or at most 15 wt. % or at most 12 wt. %.

The polyether chains of the first polyether polyol may comprise no ethylene oxide content but may comprise only propylene oxide and/or butylene oxide content, suitably only propylene oxide content.

Further, the first polyether polyol may comprise primary hydroxyl groups. The primary hydroxyl content of the first polyether polyol may be 0% or at least 1% or at least 3% or at least 5%. Further, the primary hydroxyl content of the first polyether polyol may be at most 15% or at most 10% or at most 5%.

Further, the first polyether polyol may have a functionality of from 2 to 6, preferably of from 2 to 4, more preferably of from 2.5 to 3.5, most preferably of from 2.7 to 3.3.

The second polyether polyol has a molecular weight of from 500 to 1, 700 g/mol. The molecular weight of the second polyether polyol is at least 500 g/mol and may be at least 700 g/mol or at least 800 g/mol or at least 850 g/mol or at least 900 g/mol. Further, the molecular weight of the second polyether polyol is at most 1,700 g/mol and may be at most 1,500 g/mol or at most 1,300 g/mol or at most 1,200 g/mol or at most 1,100 g/mol.

Further, the second polyether polyol has a hydroxyl value of from 50 to 650 mg KOH/g. The hydroxyl value of the second polyether polyol is at least 50 mg KOH/g, more preferably at least 90 mg KOH/g, more preferably above 90 mg KOH/g, more preferably at least 100 mg KOH/g, more preferably at least 120 mg KOH/g, most preferably at least 140 mg KOH/g. Further, the hydroxyl value of the second polyether polyol is at most 650 mg KOH/g, more preferably at most 450 mg KOH/g, more preferably at most 300 mg KOH/g, more preferably at most 250 mg KOH/g, most preferably at most 200 mg KOH/g.

Further, the second polyether polyol has an ethylene oxide content above 30 wt. % and a propylene oxide content below 50 wt. %. The second polyether polyol comprises polyether chains containing ethylene oxide content (more than 30 wt. %), a propylene oxide content (less than 50 wt. %) and optionally butylene oxide content, suitably only ethylene oxide and propylene oxide contents.

Preferably, the ethylene oxide content of the second polyether polyol is at least 50 wt. %, more preferably at least 60 wt. %, more preferably at least 70 wt. %, more preferably at least 75 wt. %, more preferably greater than 75 wt. %, more preferably at least 77 wt. %, most preferably at least 80 wt. %. Further, preferably, the ethylene oxide content of the second polyether polyol is at most 99 wt. %, more preferably at most 95 wt. %, more preferably at most 90 wt. %, more preferably at most 87 wt. %, most preferably at most 85 wt. %.

Preferably, the propylene oxide content of the second polyether polyol is at least 1 wt. %, more preferably at least 5 wt. %, more preferably at least 10 wt. %, more preferably at least 13 wt. %, most preferably at least 15 wt. %. Further, preferably, the propylene oxide content of the second polyether polyol is at most 50 wt. %, more preferably at most 40 wt. %, more preferably at most 30 wt. %, more preferably at most 25 wt. %, most preferably at most 20 wt. %.

Further, preferably, the second polyether polyol has a weight ratio of ethylene oxide to propylene oxide of at least 1:1, more preferably at least 2:1, more preferably at least 3:1, more preferably at least 3.5:1, more preferably at least 4:1, most preferably at least 4.5:1. Further, preferably, the weight ratio of ethylene oxide to propylene oxide of the second polyether polyol is at most 20:1, more preferably at most 15:1, more preferably at most 10:1, more preferably at most 7:1, more preferably at most 6:1, most preferably at most 5:1.

Further, the second polyether polyol comprises primary hydroxyl groups. The second polyether polyol has a primary hydroxyl content below 40%. Preferably, the primary hydroxyl content of the second polyether polyol is at least 1%, more preferably at least 5%, more preferably at least 10%, more preferably at least 14%, most preferably at least 17%. Further, preferably, the primary hydroxyl content of the second polyether polyol is at most 35%, more preferably at most 30%, more preferably at most 25%, more preferably at most 23%, most preferably at most 21%.

Further, the second polyether polyol may have a functionality of from 2 to 6, preferably of from 2 to 4, more preferably of from 2.5 to 3.5, most preferably of from 2.7 to 3.3.

It is preferred that in preparing the second polyether polyol having both an ethylene oxide content and a propylene oxide content, only ethylene oxide is added in an initial step for reaction with the initiator, followed by the addition of only propylene oxide in a further step. This results in the second polyether polyol having an ethylene oxide middle block and a propylene oxide end block, which may also be referred to as “PO tip”. Accordingly, such polyether polyol has a relatively low primary hydroxyl content which may be within the above-described ranges.

In the present invention, the weight ratio of the first polyether polyol to the second polyether polyol may advantageously range widely. As demonstrated in the below Examples, the present invention makes it possible, by using the second polyether polyol in combination with the first polyether polyol, to vary the porosity of a polyurethane foam over a wide range, simply by varying the relative amount of the second polyether polyol with respect to the amount of the first polyether polyol, without experiencing any foam sink back.

Accordingly, the weight ratio of the first polyether polyol to the second polyether polyol may advantageously range widely and may be of from 0.01:1 to 100:1. Said weight ratio may be at least 0.01:1 or at least 0.05:1 or at least 0.1:1 or at least 0.3:1 or at least 0.5:1 or at least 0.9:1 or at least 1.5:1. Further, said weight ratio may be at most 100:1 or at most 70:1 or at most 50:1 or at most 40:1 or at most 30:1 or at most 20:1 or at most 10:1 or at most 5:1.

Further, it is preferred that in the present polyurethane foam preparation process no monol is added, in addition to the first and second polyether polyols which are added for reaction with the polyisocyanate. A monol is an alcohol containing one hydroxyl group, whereas a polyol is an alcohol containing two or more hydroxyl groups.

Further, in the present invention, polyether polyol component a) may additionally comprise a3) a third polyether polyol which is different from each of the first and second polyether polyols, and which third polyether polyol has a molecular weight of from 2,000 to 12,000 g/mol, a hydroxyl value of from 10 to 90 mg KOH/g and a propylene oxide content above 50 wt. %.

The third polyether polyol has a molecular weight of from 2,000 to 12,000 g/mol. The molecular weight of the third polyether polyol is at least 2,000 g/mol and may be at least 2,300 g/mol or at least 2,500 g/mol or at least 2,700 g/mol. Further, the molecular weight of the third polyether polyol is at most 12,000 g/mol and may be at most 8,000 g/mol or at most 5,000 g/mol or at most 4,000 g/mol or at most 3,500 g/mol or at most 3,000 g/mol.

Further, the third polyether polyol has a hydroxyl value of from 10 to 90 mg KOH/g. The hydroxyl value of the third polyether polyol is at least 10 mg KOH/g, more preferably at least 30 mg KOH/g, more preferably at least 40 mg KOH/g, most preferably at least 50 mg KOH/g. Further, the hydroxyl value of the third polyether polyol is at most 90 mg KOH/g, more preferably at most 80 mg KOH/g, more preferably at most 70 mg KOH/g, most preferably at most 65 mg KOH/g.

Further, the third polyether polyol has a propylene oxide content above 50 wt. %. The third polyether polyol comprises polyether chains containing propylene oxide content (more than 50 wt. %), optionally butylene oxide content and optionally ethylene oxide content, suitably only ethylene oxide content, more suitably only propylene oxide and ethylene oxide contents.

Preferably, the propylene oxide content of the third polyether polyol is at least 50 wt. %, more preferably at least 70 wt. %, more preferably at least 80 wt. %, more preferably at least 85 wt. %, most preferably at least 90 wt. %. Further, preferably, the propylene oxide content of the third polyether polyol is at most 100 wt. %, more preferably at most 98 wt. %, more preferably at most 96 wt. %, most preferably at most 94 wt. %.

Preferably, the ethylene oxide content of the third polyether polyol is at least 0 wt. %, more preferably at least 2 wt. %, more preferably at least 4 wt. %, most preferably at least 6 wt. %. Further, preferably, the ethylene oxide content of the third polyether polyol is at most 50 wt. %, more preferably at most 30 wt. %, more preferably at most 20 wt. %, more preferably at most 15 wt. %, most preferably at most 10 wt. %.

Further, the third polyether polyol may comprise primary hydroxyl groups. The primary hydroxyl content of the third polyether polyol may be 0% or at least 3% or at least 6% or at least 8%. Further, the primary hydroxyl content of the third polyether polyol may be at most 25% or at most 20% or at most 15%.

Further, the third polyether polyol may have a functionality of from 2 to 6, preferably of from 2 to 4, more preferably of from 2.5 to 3.5, most preferably of from 2.7 to 3.3.

The third polyether polyol may be part of a polymer polyol. That is to say, one or more polymers may be dispersed in the third polyether polyol. In particular, a solid polymer may be dispersed in said polyol, thereby forming a “polymer polyol”. The base polyol of such polymer polyol may have properties as described above for the third polyether polyol in general. Thus, in general, a polymer polyol is a dispersion of a solid polymer in a liquid polyol. Such systems are well known in the art and are normally prepared by polymerising one or more ethylenically unsaturated monomers in the presence of a free radical catalyst.

Examples of such polymer polyol systems and methods for their preparation are disclosed in, for instance, EP076491A2, EP0343907A2 and EP0495551A2. Polyurea or polyurethane polymers are also known to be useful as the dispersed polymer in polymer polyols instead of the polymers based on ethylenically unsaturated monomers.

The polymer dispersed in the base polyol, may in principle be any such polymer known to be applicable for this purpose. Thus, suitable polymers include the polymers based on ethylenically unsaturated monomers and particularly polymers of vinyl aromatic hydrocarbons, like styrene, alpha-methyl styrene, methyl styrene and various other alkyl-substituted styrenes. Of these, the use of styrene is preferred. The vinyl aromatic monomer may be used alone or in combination with other ethylenically unsaturated monomers, such as acrylonitrile, methacrylonitrile, vinylidene chloride, various acrylates and conjugated dienes like 1,3-butadiene and isoprene. Preferred polymers, however, are polystyrene and styrene-acrylonitrile (SAN) copolymers. Another suitable class of polymers are the polyurea and polyurethane polymers. Particularly the condensation products of primary amines or polyhydric alcohol amines and aromatic diisocyanates are very useful in this respect. One suitable polymer is the condensation product of triethanolamine and toluene diisocyanate (TDI).

In case in the present invention, polyether polyol component a) additionally comprises above-described third polyether polyol, the weight ratio of the third polyether polyol to the combination of the first and second polyether polyols may be of from 0.01:1 to 10:1. Said weight ratio may be at least 0.01:1 or at least 0.05:1 or at least 0.1:1 or at least 0.15:1 or at least 0.2:1. Further, said weight ratio may be at most 50:1 or at most 20:1 or at most 10:1 or at most 5:1 or at most 1:1 or at most 0.7:1 or at most 0.5:1 or at most 0.3:1.

In the above-described case of using a combination of the first, second and third polyether polyols, polyether polyol component a) may comprise of from 40 to 90 wt. %, more suitably of from 60 to 85 wt. %, of the first and second polyether polyols in combination, and 10 to 60 wt. %, more suitably of from 15 to 40 wt. %, of the third polyether polyol.

The present invention also relates to a composition comprising the first polyether polyol and the second polyether polyol as described above. The above-discussed embodiments and preferences in relation to the first and second polyether polyols as used in the polyurethane foam preparation process of the present invention, equally apply to the first and second polyether polyols as contained in said composition.

In the present process, polyether polyol component a) is reacted with a polyisocyanate in the presence of a blowing agent.

The polyisocyanate may comprise an aromatic polyisocyanate or an aliphatic polyisocyanate, preferably an aromatic polyisocyanate.

The aromatic polyisocyanate may for example comprise tolylene diisocyanate (TDI) or polymeric TDI, xylylene diisocyanate, tetramethylxylylene diisocyanate, methylene diphenyl diisocyanate (MDI) or polymeric MDI (i.e. polymethylene polyphenyl isocyanate), or a modified product thereof. Preferably, the aromatic polyisocyanate comprises tolylene diisocyanate (TDI), i.e. non-polymeric TDI. The TDI may be a mixture of 80 wt. % of 2,4-TDI and 20 wt. % of 2,6-TDI, which mixture is sold as “TDI-80”.

Further, the aliphatic polyisocyanate may for example comprise hexamethylene diisocyanate, dicyclohexylmethane diisocyanate, lysine diisocyanate or isophorone diisocyanate, or a modified product thereof.

Further, the polyisocyanate may comprise any mixture of two or more of the polyisocyanates mentioned above. For example, the polyisocyanate may comprise a mixture of TDI and MDI, in particular a mixture wherein the weight ratio of TDI:MDI varies from 10:90 to 90:10.

In the present invention, the blowing agent may comprise a chemical blowing agent and/or a physical (non-chemical) blowing agent. Within the present specification, by “chemical blowing agent” reference is made to a blowing agent that may only provide a blowing effect after it has chemically reacted with another compound. In case the blowing agent comprises a chemical blowing agent, said chemical blowing agent preferably comprises water. Water reacts with isocyanate groups of the polyisocyanate, thereby releasing carbon dioxide which causes the blowing to occur.

However, other suitable blowing agents, such as for example, acetone, gaseous or liquid carbon dioxide, halogenated hydrocarbons, aliphatic alkanes and alicyclic alkanes may be employed additionally or alternatively.

Due to the ozone depleting effect of fully chlorinated, fluorinated alkanes (CFC's) the use of this type of blowing agent is generally not preferred, although it is possible to use them within the scope of the present invention. Halogenated alkanes, wherein at least one hydrogen atom has not been substituted by a halogen atom (including the so-called HCFC's) have no or less ozone depleting effect and therefore are the preferred halogenated hydrocarbons to be used in physically blown foams. One suitable HCFC type blowing agent is 1-chloro-1,1-difluoroethane. Another suitable halogenated alkane of this type for use as a blowing agent, is methylene chloride (dichloromethane).

The above blowing agents may be used singly or in mixtures of two or more.

The amount of the blowing agent(s) is determined by the desired density of the polyurethane foam to be prepared. For example, a relatively low density can be obtained by using a relatively high amount of the blowing agent(s), and vice versa. A skilled person can readily determine the amount of blowing agent (physical and/or chemical blowing agent) needed to obtain a desired foam density.

In the present invention, water may be used as a blowing agent in an amount which is at least 0.1 part per hundred parts by weight of polyol (pphp) or at least 0.5 pphp or at least 1 pphp. Further, in the present invention, water may be used as a blowing agent in an amount which is at most 10 parts per hundred parts by weight of polyol (pphp) or at most 5 pphp or at most 3 pphp or at most 2 pphp.

In case of halogenated hydrocarbons, aliphatic alkanes and alicyclic alkanes, the amount of the blowing agent may be of from 1 to 50 parts per hundred parts by weight of polyol (pphp), suitably of from 1 to 30 pphp, more suitably of from 1 to 20 pphp.

Further, preferably, the polyurethane foam to be prepared in the present process is a flexible polyurethane foam. Further, said flexible polyurethane foam is suitably a slabstock foam. Within the present specification, by “slabstock foam” reference is made to a foam that is made by applying a free rise (unconstrained rise) of the foam.

In the present invention, the isocyanate index (or NCO index) may be relatively low, which is especially desired in case viscoelastic (VE) properties are desired for the resulting foam. The isocyanate index may be at most 120, more suitably at most 110, more suitably at most 100, most suitably at most 90. Further, the isocyanate index is preferably higher than 60 and may be at least 70 or at least 80.

Within the present specification, “isocyanate index” is calculated as 100 times the mole ratio of —NCO groups (isocyanate groups) to NCO-reactive groups in the reaction mixture. In other words, the isocyanate index is defined as: [(actual amount of isocyanate)/(theoretical amount of isocyanate)]*100, wherein the “theoretical amount of isocyanate” equals 1 equivalent isocyanate (NCO) group per 1 equivalent isocyanate-reactive group.

Such “isocyanate-reactive groups” as referred to above include for example OH groups from polyether polyol component a) and from any water that may be used as a blowing agent. Isocyanate groups also react with water.

Still further, preferably, the polyurethane foam to be prepared in the present process has a relatively low resilience. Resilience provides a measure of the surface elasticity of a foam and can relate to comfort or “feel”. Resilience is typically measured by dropping a steel ball onto a foam and measuring how high the ball rebounds. This test is typically referred to as “ball rebound test”. A suitable ball rebound test method is the “ASTM D3574—Test H” method.”. In the present invention, the polyurethane foam may have a resilience below 40%, suitably below 35%, more suitably below 30% and most suitably said resilience is at most 25% or at most 20% or at most 15%. Further, said resilience may be at least 1% or at least 2%. Said resilience for the polyurethane foam in the present invention may be measured by Test H from the above-mentioned ASTM D3574 method.

Additionally, other components may also be present during the polyurethane preparation process of the present invention, such as one or more polyurethane catalysts, surfactants and/or cross-linking agents.

Polyurethane catalysts are known in the art and include many different compounds. For the purpose of the present invention, suitable catalysts include tin-, lead- or titanium-based catalysts, preferably tin-based catalysts, such as tin salts and dialkyl tin salts of carboxylic acids. Specific examples are stannous octoate, stannous oleate, dibutyltin dilaureate, dibutyltin acetate and dibutyltin diacetate. Other suitable catalysts are tertiary amines, such as, for instance, bis(2,2′-dimethylamino)ethyl ether, trimethylamine, triethylamine, triethylenediamine and dimethylethanolamine (DMEA). Examples of commercially available tertiary amine catalysts are those sold under the tradenames Niax, Tegoamin and Dabco (all trademarks). The catalyst is typically used in an amount of from 0.01 to 2.0 parts by weight per hundred parts by weight of polyether polyol (php). Preferred amounts of catalyst are from 0.05 to 1.0 php.

The use of foam stabilisers (surfactants) is well known. Organosilicone surfactants are most conventionally applied as foam stabilisers in polyurethane production. A large variety of such organosilicone surfactants is commercially available. Usually, such foam stabiliser is used in an amount of from 0.01 to 5.0 parts by weight per hundred parts by weight of polyol (pphp). Preferred amounts of stabiliser are from 0.25 to 2.0 pphp, more preferably of from 0.75 to 1.5 pphp.

The use of cross-linking agents in the production of polyurethane foams is also well known. Polyfunctional glycol amines are known to be useful for this purpose. The polyfunctional glycol amine which is most frequently used and is also useful in the preparation of polyurethane foams, especially flexible polyurethane foams, is diethanol amine, often abbreviated as DEOA. A cross-linking agent may be applied in amounts up to 2 parts by weight per hundred parts by weight of polyol (pphp), but amounts in the range of from 0.01 to 0.5 pphp are most suitably applied.

In addition, other well-known auxiliaries, such as colorants, flame retardants and fillers, may also be used during the polyurethane preparation process of the present invention.

The process of the invention may involve combining the polyisocyanate, polyether polyol component a), the blowing agent, a catalyst and optionally surfactant, crosslinker, flame retardant, colorant and/or filler, in any suitable manner to obtain the polyurethane foam. For example, the present process may comprise mixing polyether polyol component a), the blowing agent, a catalyst and any other optional component(s) except the polyisocyanate, and then adding the polyisocyanate.

Further, the process of the invention may comprise forming the foam into a shaped article before it fully sets. Suitably, forming the foam may comprise pouring the liquid mixture containing all components into a mould before gelling is complete.

The present invention also relates to a polyurethane foam obtainable by the above-described process, and to a shaped article comprising the polyurethane foam obtained by the above-described process or a polyurethane foam obtainable by the above-described process.

The invention is further illustrated by the following Examples.

### Examples

### 1. Experimental Procedure

Materials (polyether polyols, polyisocyanate and other components) used in the polyurethane foam experiments are described in Table 1 below.

TABLE 1

| | |
|---|---|
| | POLYETHER POLYOLS |
| Polyol A | Made by ring-opening polymerization of propylene |
| | oxide in the presence of KOH catalyst and glycerol: |
| | MW = 675 g/mol; OH number = 250 mg KOH/g; PO |
| | content = 100 wt. %; PHC = 0%; corresponds with the |
| | above-described first polyether polyol |
| Polyol B | Made by ring-opening polymerization of alkylene |
| | oxide in the presence of KOH catalyst and glycerol: |
| | MW = 1,000 g/mol; OH number = 165 mg KOH/g; |
| | EO content = 82 wt. %; PO content = 18 wt. %; PHC = |
| | 18.6; PO tipped; corresponds with the above- |
| | described second polyether polyol |
| Polyol C | Made by ring-opening polymerization of alkylene |
| | oxide in the presence of DMC catalyst, monopropylene |
| | glycol and glycerol: MW = 2,800 g/mol; OH number = |
| | 56 mg KOH/g; EO content = 8 wt. %; PO content = 92 |
| | wt. %; PHC = 11%; EO and PO randomly distributed; |
| | corresponds with the above-described third polyether |
| | polyol |
| Polyol D | Made by ring-opening polymerization of alkylene |
| | oxide in the presence of KOH catalyst and glycerol: |
| | MW = 4,600 g/mol; OH number = 36 mg KOH/g; EO |
| | content = 75 wt. %; PO content = 25 wt. %; PHC = 90%; |
| | EO tipped |
| | POLYISOCYANATE |
| TDI-80 | 80:20 (by weight) blend of 2,4- and 2,6-isomers of |
| | TDI (tolylene diisocyanate) commercially available |
| | from Mitsui; free NCO content = 48.3% |
| | OTHER COMPONENTS |
| T-9 | Stannous octoate catalyst, commercially available |
| | from Air Products and Chemicals |
| Niax A1 | Amine based catalyst available from Momentive |
| | Performance Materials |
| Niax A33 | Amine based catalyst available from Momentive |
| | Performance Materials |
| Niax L627 | Silicone based surfactant commercially available |
| | from Momentive Performance Materials |

DMC=double metal cyanide; KOH=potassium hydroxide; EO=ethylene oxide; PO=propylene oxide; EO and PO contents based on total alkylene oxide weight; MW=molecular weight; PHC=primary hydroxyl content

In the polyurethane foam experiments, the non-polyisocyanate components were mixed in a high-speed mixer at about 2,500 rpm for 50 seconds. Then the polyisocyanate component was added and the mixture was stirred for around 5 seconds and then poured into a box of dimensions of 30 cm*20 cm*15 cm to form a polyurethane foam. The full rise time was measured. The full rise time was the time period between the time of adding the polyisocyanate and the time at which a maximum height was achieved.

Further, the following properties of the foams thus obtained were measured:
1) Density according to ASTM D3574—Test A, with sample size of 100*100*50 mm³ and 2 samples/foam.
2) Porosity using an “IDM” foam porosity tester according to ASTM D3574—Test G, in which a 50*50*25 mm³ foam sample is placed in a vacuum chamber cavity and a specified automatic constant differential air pressure (125 Pa) is applied. The readings of air volume are recorded in litres/min.
3) Recovery time according to ASTM D3574—Test M, with 100*100*50 mm³ foam samples. Recovery time (RT) to 1 N was measured.
4) Resilience according to ASTM D3574—Test H, with sample size of 100*100*50 mm³ and 2 samples/foam. This involves dropping a 16 mm diameter steel ball onto a sample and measuring the percentage height that the ball rebounded.

### 2. Polyurethane Foam Experiments

Polyurethane foams were made in accordance with the recipes as shown in Table 2 below, which also shows foam properties such as full rise time, foam sink back (yes/no), density, porosity, recovery time (RT) and resilience.

As can be seen in Table 1 above, Polyols A, B and C correspond with the first polyether polyol, second polyether polyol and third polyether polyol, respectively, as described above in relation to the present invention.

Further, Polyol D is different from Polyol B in that for Polyol B the molecular weight is relatively low and the OH number is relatively high, whereas for Polyol D the molecular weight is relatively high and the OH number is relatively low. Further, Polyol B is PO tipped (having mainly secondary hydroxyl groups from PO at the end of the polyether chains) resulting in a relatively low primary hydroxyl content (PHC). On the contrary, Polyol D is EO tipped (having mainly primary hydroxyl groups from EO at the end of the polyether chains) resulting in a relatively high PHC. However, Polyols B and D have in common that both were made by ring-opening polymerization of propylene oxide and ethylene oxide in the presence of KOH catalyst and glycerol, and both have a relatively high EO content and a relatively low PO content. Polyol D is the same polyol as the polyether polyol that is referred to as “Caradol SA36-02” in above-discussed WO2019086655.

Experiment 1 is a reference experiment, wherein only Polyols A and C were used without either Polyol B or Polyol D. As can be seen in Table 2, the resulting foam in Experiment 1 did not sink back and had a porosity of 6 l/min. Experiments 2-6 are comparison experiments wherein in addition to Polyols A and C, Polyol D was also used. By increasing the amount of Polyol D, it was possible to increase the porosity of the foam, from 9 l/min (Experiment 2:2 pbw of Polyol D) to 39 l/min (Experiment 5:15 pbw of Polyol D). However, disadvantageously, it was not possible to further increase the porosity without a sink back of the resulting foam. For in Experiment 6, wherein 20 pbw of Polyol D were used, the foam experienced a sink back indicating a low foam stability at high amounts of Polyol D, that is to say at 20 pbw and higher.

In Experiments 7-15, which are in accordance with the present invention, Polyol B was used instead of Polyol D as used in Experiments 2-6. Surprisingly and advantageously, also with Polyol B it was possible to increase the porosity of the foam. However, unlike the foam in Experiment 5 using 20 pbw of Polyol D, the foams in Experiments 7-15 did not experience any sink back at any of the tested amounts of Polyol B which varied over a wide range from 2 to 60 pbw. This indicates a high foam stability, both at low amounts of Polyol B and at high amounts of Polyol B.

As a consequence, surprisingly and advantageously, the present invention makes it possible, when using the above-described second polyether polyol (e.g. Polyol B) in combination with the above-described first polyether polyol (e.g. Polyol A), to vary the porosity of a polyurethane foam over a wide range, simply by varying the amount of said second polyol and without experiencing any foam sink back. Thus, the present invention has a wide applicability range (high tunability) in that depending on the specific foam application and correspondingly required specific foam porosity, the relative amount of said second polyol with respect to said first polyol is simply either increased or decreased without any foam sink back.

TABLE 2

| Experiments ¹⁾ | 1 | 2 | 3 | 4 | 5 | 6 | 7 | 8 |
|---|---|---|---|---|---|---|---|---|
| Polyol | 80 | 78 | 75 | 70 | 65 | 60 | 78 | 75 |
| A (pbw) | | | | | | | | |
| Polyol | 0 | 0 | 0 | 0 | 0 | 0 | 2 | 5 |
| B (pbw) | | | | | | | | |
| Polyol | 20 | 20 | 20 | 20 | 20 | 20 | 20 | 20 |
| C (pbw) | | | | | | | | |
| Polyol | 0 | 2 | 5 | 10 | 15 | 20 | 0 | 0 |
| D (pbw) | | | | | | | | |
| Water | 1.0 | 1.0 | 1.0 | 1.0 | 1.0 | 1.0 | 1.0 | 1.0 |
| (pbw) | | | | | | | | |
| T-9 | 0.03 | 0.03 | 0.03 | 0.03 | 0.03 | 0.03 | 0.03 | 0.03 |
| (pbw) | | | | | | | | |
| Niax | 0.25 | 0.25 | 0.25 | 0.25 | 0.25 | 0.25 | 0.25 | 0.25 |
| A1 (pbw) | | | | | | | | |
| Niax | 0.75 | 0.75 | 0.75 | 0.75 | 0.75 | 0.75 | 0.75 | 0.75 |
| A33 (pbw) | | | | | | | | |
| Niax | 1.1 | 1.1 | 1.1 | 1.1 | 1.1 | 1.1 | 1.1 | 1.1 |
| L627 (pbw) | | | | | | | | |
| TDI-80 | 87 | 87 | 87 | 87 | 87 | 87 | 87 | 87 |
| (isocyanate | | | | | | | | |
| index) | | | | | | | | |
| Properties | | | | | | | | |
| Full rise | 117 | 123 | 128 | 137 | 144 | 139 | 119 | 120 |
| time (s) | | | | | | | | |
| Foam sink | No | No | No | No | No | Yes | No | No |
| back? | | | | | | | | |
| Density | 65 | 63 | 64 | 62 | 61 | 70 | 66 | 66 |
| (kg/m³) | | | | | | | | |
| Porosity | 6 | 9 | 9 | 22 | 39 | 52 | 7 | 10 |
| (1/min) | | | | | | | | |
| RT to | 18 | 33 | 14 | 12 | 6 | 6 | 13 | 11 |
| 1N (s) | | | | | | | | |
| Resilience | 2 | 2 | 2 | 5 | 7 | 10 | 3 | 3 |
| (%) | | | | | | | | |

| Experiments ¹⁾ | 9 | 10 | 11 | 12 | 13 | 14 | 15 |
|---|---|---|---|---|---|---|---|
| Polyol | 70 | 65 | 60 | 50 | 40 | 30 | 20 |
| A (pbw) | | | | | | | |
| Polyol | 10 | 15 | 20 | 30 | 40 | 50 | 60 |
| B (pbw) | | | | | | | |
| Polyol | 20 | 20 | 20 | 20 | 20 | 20 | 20 |
| C (pbw) | | | | | | | |
| Polyol | 0 | 0 | 0 | 0 | 0 | 0 | 0 |
| D (pbw) | | | | | | | |
| Water | 1.0 | 1.0 | 1.0 | 1.0 | 1.0 | 1.0 | 1.0 |
| (pbw) | | | | | | | |
| T-9 | 0.03 | 0.03 | 0.03 | 0.03 | 0.03 | 0.03 | 0.03 |
| (pbw) | | | | | | | |
| Niax | 0.25 | 0.25 | 0.25 | 0.25 | 0.25 | 0.25 | 0.25 |
| A1 (pbw) | | | | | | | |
| Niax | 0.75 | 0.75 | 0.75 | 0.75 | 0.75 | 0.75 | 0.75 |
| A33 (pbw) | | | | | | | |
| Niax | 1.1 | 1.1 | 1.1 | 1.1 | 1.1 | 1.1 | 1.1 |
| L627 (pbw) | | | | | | | |
| TDI-80 | 87 | 87 | 87 | 87 | 87 | 87 | 87 |
| (isocyanate | | | | | | | |
| index) | | | | | | | |
| Properties | | | | | | | |
| Full rise | 121 | 118 | 117 | 123 | 138 | 150 | 152 |
| time (s) | | | | | | | |
| Foam sink | No | No | No | No | No | No | No |
| back? | | | | | | | |
| Density | 65 | 63 | 64 | 63 | 62 | 62 | 63 |
| (kg/m³) | | | | | | | |
| Porosity | 14 | 26 | 37 | 81 | 105 | 120 | 165 |
| (1/min) | | | | | | | |
| RT to | 9 | 7 | 9 | 5 | 4 | 4 | 5 |
| 1N (s) | | | | | | | |
| Resilience | 4 | 5 | 8 | 12 | 17 | 19 | 24 |
| (%) | | | | | | | |

pbw = parts by weight
¹⁾ Experiment 1 is a reference experiment and Experiments 2-6 are comparison experiments (not in accordance with the present invention); Experiments 7-15 are experiments in accordance with the present invention

1. A process for preparing a polyurethane foam, comprising reacting a polyisocyanate with a polyether polyol component a) in the presence of a blowing agent, wherein polyether polyol component a) comprises:
a1) a first polyether polyol having a molecular weight of from 300 to 1,500 g/mol, a hydroxyl value of from 100 to 650 mg KOH/g and a propylene oxide content above 50 wt. %; and
a2) a second polyether polyol having a molecular weight of from 500 to 1,700 g/mol, a hydroxyl value of from 50 to 650 mg KOH/g, an ethylene oxide content above 30 wt. %, a propylene oxide content below 50 wt. % and a primary hydroxyl content below 40%.

2. The process according to claim 1, wherein the first polyether polyol has an ethylene oxide content below 30 wt. %.

3. The process according to claim 1, wherein the first polyether polyol has a primary hydroxyl content of at most 15%.

4. The process according to claim 1, wherein the second polyether polyol has a hydroxyl value of from 100 to 650 mg KOH/g.

5. The process according to claim 1, wherein the weight ratio of the first polyether polyol to the second polyether polyol is of from 0.01:1 to 100:1.

6. The process according to claim 1, wherein polyether polyol component a) additionally comprises:
a3) a third polyether polyol having a molecular weight of from 2,000 to 12,000 g/mol, a hydroxyl value of from 10 to 90 mg KOH/g and a propylene oxide content above 50 wt. %.

7. The process according to claim 6, wherein the weight ratio of the third polyether polyol to the combination of the first and second polyether polyols is of from 0.01:1 to 10:1.

8. A composition comprising the first polyether polyol and the second polyether polyol as described in claim 1.

9. A polyurethane foam obtainable by the process according to claim 1.

10. A shaped article comprising a polyurethane foam obtained by the process according to claim 1.
